(19) United States
(12) Patent Application Publication
(10) Pub. No.: US 2023/0020991 A1
(43) Pub. Date: Jan. 19, 2023

(54) COLD-ROLLED STEEL SHEET FOR STRUCTURAL SECTION HAVING EXCELLENT HARDNESS AND PROCESSABILITY, AND METHOD FOR MANUFACTURING SAME

(71) Applicant: POSCO, Pohang-si, Gyeongsangbuk-do (KR)

(72) Inventors: Minho Jo, Pohang-si, Gyeongsangbuk-do (KR); Young-Kwang Hong, Pohang-si, Gyeongsangbuk-do (KR)

(73) Assignee: POSCO, Pohang-si, Gyeongsangbuk-do (KR)

(21) Appl. No.: 17/784,456

(22) PCT Filed: Dec. 9, 2020
(86) PCT No.: PCT/KR2020/017977

§ 371 Date: Jun. 10, 2022

(30) Foreign Application Priority Data
Dec. 19, 2019 (KR) 10-2019-0170757

(51) Int. Cl. C21D 8/02; C21D 9/46; C22C 38/00; C22C 38/02; C22C 38/04; C22C 38/06; C22C 38/14; C23C 2/06; C23C 2/40

(52) U.S. Cl. CPC C21D 8/0236; C21D 8/0226; C21D 9/46; C22C 38/001; C22C 38/002; C22C 38/02; C22C 38/04; C22C 38/06; C22C 38/14; C23C 2/06; C23C 2/40

(57) ABSTRACT

A cold-rolled sheet according to an example of the present invention comprises at most 0.004 wt % (exclusive of 0 wt %) of C, at most 0.02 wt % (exclusive of 0 wt %) of Si, 0.1 to 0.3 wt % of Mn, at most 0.05 wt % (exclusive of 0 wt %) of Al, at most 0.02 wt % (exclusive of 0 wt %) of P, at most 0.001 wt % (exclusive of 0 wt %) of S, at most 0.004 wt % (exclusive of 0 wt %) of N, 0.015 to 0.035 wt % of Ti, and 0.001 to 0.003 wt % of B, with the balance being Fe and other inevitable impurities, and has a microstructure in which the crystal grain aspect ratio defined by the following equation 1 is 1.4 to 4.0.

Crystal grain aspect ratio=average crystal grain diameter in the rolling direction/average crystal grain diameter in the thickness direction [Equation 1]

### TECHNICAL FIELD

The present invention relates to a cold-rolled steel sheet having excellent hardness and processability and a method for manufacturing the same. More specifically, the present invention relates to a cold-rolled steel sheet having high hardness and excellent formability that may be processed as various types of structural materials, and a method for economically manufacturing the same.

### BACKGROUND ART

A cold-rolled steel sheet is subjected to various types of surface treatment and then is used as a structural material for many uses such as construction materials. In the case where the cold-rolled steel sheet has high hardness when used as a structural material, the cold-rolled steel sheet has an advantage of being able to withstand deformation due to external force after being formed. In particular, when aesthetic characteristics of a surface are required, such as electronic products, it is important to maintain flatness of the surface by having a high hardness.

As a method for increasing hardness of a steel sheet, various methods such as solid solution strengthening, precipitation strengthening, work hardening, and hard phase control are used. Among them, the solid solution strengthening requires the addition of a large amount of alloy elements, and a method of controlling a hard phase also has a disadvantage of lowering economic efficiency during manufacturing by adding a large amount of alloy elements to increase hardenability or requiring a rapid cooling process after annealing. The precipitation strengthening also requires the addition of expensive alloy elements to form precipitates, and has a disadvantage in that cold rollability is greatly reduced when excessive precipitates are formed.

Unlike the above method, the work hardening may be used as an economical method because the work hardening may improve strength by generating high dislocations by simple cold rolling without adding alloy elements. However, it is important to secure formability after the work hardening because the formability is greatly reduced due to the high dislocation density after the work hardening. In addition, since deterioration in formability increases as the amount of work hardening increases, it is important to determine an appropriate amount of work hardening to secure the formability. For a cold-rolled steel sheet having a general compositional system, in order to secure hardness (HRB) of 75 or higher, a cold reduction ratio of about 20% is required, and when the cold reduction ratio exceeds 20%, it is difficult to secure the formability due to deterioration in elongation.

As a technology to secure hardness by using work hardening, a method for manufacturing a cold-rolled steel sheet having high hardness by performing hot rolling, primary cold rolling, continuous annealing, and secondary cold rolling on a low-carbon steel slab with 0.01 to 0.1 wt% of C is proposed. In the above technology, in order to alleviate the problem of the above-described deterioration in elongation, the reduction ratio is limited to 15% or less during the secondary cold rolling which is a work hardening process. Because the work hardening reduction ratio due to the secondary cold reduction ratio is as low as 15% or less, the material up to the previous manufacturing process should not have a large difference from a target thickness. However, in general, since the limit of the thickness of hot rolling is generally 1 mm or more, in order to obtain a steel sheet with a much thinner thickness, a process of reducing a thickness through primary cold rolling with a reduction ratio of 50% or more after hot rolling and then relieving a stress caused by work hardening by recrystallizing through continuous annealing is required. That is, since two additional processes are performed to obtain a desired thin target thickness, there is a problem in lowering productivity and economic efficiency.

### DISCLOSURE

### Technical Problem

The present invention has been made in an effort to provide a cold-rolled steel sheet having excellent hardness and processability and a method for manufacturing the same. The present invention has been made in an effort to provide a cold-rolled steel sheet having high hardness and excellent formability that may be processed as various types of structural materials, and a method for economically manufacturing the same.

### Technical Solution

An exemplary embodiment of the present invention provides a cold-rolled steel sheet including at most 0.004 wt % (exclusive of 0 wt %) of C, at most 0.02 wt % (exclusive of 0 wt %) of Si, 0.1 to 0.3 wt % of Mn, at most 0.05 wt % (exclusive of 0 wt %) of Al, at most 0.02 wt % (exclusive of 0 wt %) of P, at most 0.001 wt % (exclusive of 0 wt %) of S, at most 0.004 wt % (exclusive of 0 wt %) of N, 0.015 to 0.035 wt % of Ti, and 0.001 to 0.003 wt % of B, with the balance being Fe and other inevitable impurities, and having a microstructure in which a crystal grain aspect ratio defined by the following equation 1 is 1.4 to 4.0.

Crystal grain aspect ratio=average crystal grain diameter in rolling direction/average crystal grain diameter in thickness direction [Equation 1]

The cold-rolled steel sheet may further include at least one of at most 0.003 wt % of Cu, at most 0.01 wt % of Nb, at most 0.03 wt % of Sb, at most 0.03 wt % of Sn, at most 0.03 wt % of Ni, at most 0.03 wt % of Cr, and at most 0.03 wt % of Mo.

Another embodiment of the present invention provides a plating steel including: the cold-rolled steel sheet of the exemplary embodiment of the present invention and a plating layer located on one surface or both surfaces of the cold-rolled steel sheet.

Yet another embodiment of the present invention provides a method for manufacturing a cold-rolled steel sheet including: manufacturing a hot-rolled steel sheet by hot rolling on a slab containing at most 0.004 wt % (exclusive of 0 wt %) of C, at most 0.02 wt % (exclusive of 0 wt %) of Si, 0.1 to 0.3 wt % of Mn, at most 0.05 wt % (exclusive of 0 wt %) of Al, at most 0.02 wt % (exclusive of 0 wt %) of P, at most 0.001 wt % (exclusive of 0 wt %) of S, at most 0.004 wt % (exclusive of 0 wt %) of N, 0.015 to 0.035 wt % of Ti, and 0.001 to 0.003 wt % of B, with the balance being Fe and other inevitable impurities; and manufacturing the cold-rolled steel sheet by cold rolling the hot-rolled steel sheet at a reduction ratio of 30 to 75%.

The method may further include, before manufacturing the hot-rolled steel sheet, heating the slab at 1150° C. or higher.

The manufacturing of the hot-rolled steel sheet may include hot finish rolling in Ar₃ or more.

The manufacturing of the hot-rolled steel sheet may include winding at 550 to 700° C.

Still yet another embodiment of the present invention provides a method for manufacturing a plating steel sheet including: manufacturing a cold-rolled steel sheet; and forming a plating layer by hot-dip plating or electroplating on one surface or both surfaces of the cold-rolled steel sheet.

### Advantageous Effects

According to an embodiment of the present invention, it is possible to provide a cold-rolled steel sheet having excellent hardness and processability while having economic efficiency without adding a large amount of expensive alloy components.

### MODE FOR INVENTION

The terms first, second, third, and the like are used to describe, but are not limited to, various parts, components, areas, layers and/or sections. These terms are used only to distinguish a part, component, region, layer, or section from other parts, components, regions, layers, or sections. Accordingly, a first part, a component, an area, a layer, or a section described below may be referred to as a second part, a component, a region, a layer, or a section without departing from the scope of the present disclosure.

Terminologies used herein are to mention only a specific exemplary embodiment, and do not limit the present invention. Singular forms used herein include plural forms as long as phrases do not clearly indicate an opposite meaning. The meaning “including” used in the present specification concretely indicates specific properties, areas, integer numbers, steps, operations, elements, and/or components, and is not to exclude presence or addition of other specific properties, areas, integer numbers, steps, operations, elements, and/or components thereof.

In addition, unless otherwise specified, % means wt %, and 1 ppm is 0.0001 wt %.

In an embodiment of the present invention, further including additional elements means that the balance of iron (Fe) is replaced and included as much as the additional amount of the additional elements.

All terms including technical terms and scientific terms used herein have the same meaning as the meaning generally understood by those skilled in the art to which the present invention pertains unless defined otherwise. All terms including technical terms and scientific terms used herein have the same meaning as the meaning generally understood by those skilled in the art to which the present invention pertains unless defined otherwise.

Hereinafter, an exemplary embodiment of the present invention will be described in detail so that a person of ordinary skill in the art to which the present invention pertains can easily implement the present invention. As those skilled in the art would realize, the described embodiments may be modified in various different ways, all without departing from the spirit or scope of the present invention.

A cold-rolled steel sheet having excellent hardness and processability according to an exemplary embodiment of the present invention relates to a cold-rolled steel sheet used for various structural materials. The material for this use should secure the processability to make the shape and the hardness to maintain the shape of the structure. To this end, when a large amount of alloy element is added in 0.5% or more, economic efficiency is lowered. Therefore, it is necessary to invent a method that can secure hardness and processability at the same time by using work hardening without adding a large amount of alloy element. In addition, by expanding the range of the final cold rolling reduction ratio for the purpose of the work hardening, it is necessary to invent a method of increasing economic efficiency by omitting a primary cold rolling and continuous annealing process performed immediately before final cold rolling for the purpose of simply obtaining a target thickness.

In order to achieve the above object, the present inventors have found that a cold-rolled steel sheet having the above target physical properties may be manufactured through the optimization of the type of alloy element, its content, and manufacturing conditions, and have completed the present invention. More specifically, by designing steel to be as soft as possible immediately after hot rolling, the range of cold rolling reduction amount to reach the target hardness was greatly expanded. As a result, it is possible to greatly improve productivity and economic efficiency by omitting additional cold rolling and annealing processes and obtaining the final thickness through one cold rolling.

The cold-rolled sheet according to an example of the present invention includes at most 0.004 wt % (exclusive of 0 wt %) of C, at most 0.02 wt % (exclusive of 0 wt %) of Si, 0.1 to 0.3 wt % of Mn, at most 0.05 wt % (exclusive of 0 wt %) of Al, at most 0.02 wt % (exclusive of 0 wt %) of P, at most 0.001 wt % (exclusive of 0 wt %) of S, at most 0.004 wt % (exclusive of 0 wt %) of N, 0.015 to 0.035 wt % of Ti, and 0.001 to 0.003 wt % of B, with the balance being Fe and other inevitable impurities, and has a microstructure in which the crystal grain aspect ratio defined by the following equation 1 is 1.4 to 4.0.
[symbol] 1]

Crystal grain aspect ratio=average crystal grain diameter in rolling direction/average crystal grain diameter in thickness direction

Hereinafter, the component composition of the cold-rolled steel sheet provided in an exemplary embodiment of the present invention will be described in detail. At this time, unless otherwise specified, the content of each component means wt %.

Carbon (C): 0.004 wt % or less

C is an element that contributes to the improvement of strength and hardness, but in the present invention, there is no lower limit for C because it is possible to secure strength by work hardening and to expand the range of cold reduction ratio for work hardening by softening steel. When C is combined with Ti and precipitates, the hardness is improved, and the range of the cold reduction ratio during work hardening is narrowed, and when the content of C is excessive, since it is difficult to prevent aging by solid solution carbon, the content of C may be limited to 0.004 wt % or less. More specifically, C may be contained in an amount of 0.0035 wt % or less. More specifically, C may be contained in an amount of 0.001 to 0.003 wt %.

Silicone (Si): 0.02 wt % or less

Si is an element that may be used as a decarburization agent, and may contribute to improvement of strength and hardness by solid solution strengthening, but in an exemplary embodiment of the present invention, steel should be softened first, and Si-based oxide is generated on the surface, and thus may cause defects during plating and lower plating ability. Therefore, Si may be contained in an amount of 0.02 wt % or less. More specifically, Si may be contained in an amount of 0.015 wt %. More specifically, Si may be contained in an amount of 0.005 to 0.013 wt %.

Manganese (Mn): 0.1 to 0.3 wt %

Mn is an element that prevents hot shortness due to solid solution S by combining with solid solution S in steel and precipitating as MnS. In order to achieve this effect, Mn may be contained in an amount of 0.1 wt % or more. However, since the work hardening effect is greatly increased with the increase of the content of Mn, in the present invention, the content may be limited to 0.3% or less in order to reduce the effect of work hardening in terms of expanding the range of the reduction amount. More specifically, Mn may be contained in an amount of 0.001 to 0.20 wt %.

Aluminum(Al): 0.05 wt % or less

Al is an element with a very large deoxidation effect, and by reacting with N in steel to precipitate AlN, it prevents formability from being deteriorated due to solid solution N. However, when a large amount is added, since the ductility is rapidly reduced, the content may be limited to 0.05 wt % or less. More specifically, Al may be contained in an amount of 0.03 wt % or less. More specifically, Al may be contained in an amount of 0.01 to 0.025 wt %.

Phosphorous (P): 0.02 wt % or less

The addition of P in a certain amount is an element that does not significantly decrease the ductility of the steel and may increase the strength. However, when P is added in excess of 0.02 wt %, P is segregated at the grain boundary to excessively harden the steel and decrease the elongation, and therefore may be limited to 0.02 wt %. More specifically, P may be contained in an amount of 0.015 wt % or less. More specifically, P may be contained in an amount of 0.001 to 0.013 wt %.

Sulfur (S): 0.01 wt % or less

Since S is an element that causes red heat brittleness in solid solution, precipitation of MnS should be induced through the addition of Mn. In addition, since excessive precipitation of MnS hardens the steel, it is not preferable in terms of softening the steel in the present invention. Therefore, the upper limit of S may be limited to 0.01 wt %. More specifically, S may be contained in an amount of 0.001 to 0.009 wt %.

Nitrogen (N): 0.004 wt % or less

N is contained as an inevitable element in steel, and since N improves strength and hardness by precipitation hardening by combining with Ti in the present invention, N is avoided. In addition, N, which is not precipitated and exists in a solid solution state, reduces ductility and reduces aging resistance as well as processability. Therefore, N may be limited to 0.004 wt % or less in consideration of the content that may be combined with Ti to all precipitate. More specifically, N may be contained in an amount of 0.0035 wt % or less. More specifically, N may be contained in an amount of 0.001 to 0.003 wt %.

Titanium(Ti) : 0.015 to 0.035 wt %

Ti contributes to increase in strength and hardness by combining with C and N and precipitating. However, in an exemplary embodiment of the present invention, since the steel should be softened as much as possible primarily, the smaller the content of the TiC and TiN precipitates, the more advantageous. However, when an amount of Ti is small, C and N are not sufficiently precipitated and exist in a solid solution state, which causes a decrease in processability due to aging, and therefore, it is necessary to add 0.015 wt % or more of Ti. Conversely, when Ti is excessively added, the upper limit may be limited to 0.035 wt % or less because the steel is hardened by solid solution strengthening. More specifically, Ti may be contained in amount of 0.018 to 0.030 wt %.

Boron (B): 0.001 to 0.003 wt %

B is an element that tends to segregate at a crystal grain interface and may contribute to preventing crystal grain coarsening in the cooling process during welding. When the amount of addition is small, since the crystal grain-based segregation effect is insignificant by combining with N to form BN, 0.001 wt % or more of B may be added to obtain the effect of improving weldability. However, in the present invention, the upper limit may be limited to 0.003 wt % because the crystal grain is refined and hardened when excessively added. More specifically, B may be contained in amount of 0.0015 to 0.0025 wt %.

At least one of at most 0.003 wt % of Cu, at most 0.01 wt % of Nb, at most 0.03 wt % of Sb, at most 0.03 wt % of Sn, at most 0.03 wt % of Ni, at most 0.03 wt % of Cr, and at most 0.03 wt % of Mo may be further contained.

In addition to the above composition, the balance preferably contains Fe and unavoidable impurities, and the steel of the present invention does not exclude the addition of other compositions. The inevitable impurities may be unintentionally mixed from raw materials or the surrounding environment in a normal steel manufacturing process, and this may not be excluded. The inevitable impurities may be understood by those skilled in the art of steel manufacturing.

The cold-rolled steel sheet according to an exemplary embodiment of the present invention has a crystal grain aspect ratio of 1.40 to 4.00 defined by Equation 1 below.

Crystal grain aspect ratio=average crystal grain diameter in rolling direction (RD direction)/average crystal grain diameter in thickness direction (ND direction) [Equation 1]

When the crystal grain aspect ratio is too low, there may be a problem in that hardness is low. When the crystal grain aspect ratio is too high, there may be a problem in that the elongation is inferior. More specifically, the crystal grain aspect ratio may be 1.50 to 3.81.

The average crystal grain diameter may be 100 μm or less.

More specifically, the average crystal grain diameter may be 10 to 100 μm.

The average crystal grain diameter may be measured on a surface parallel to a rolling surface (ND surface), and assuming an imaginary circle having the same area as the crystal grain, it may be the diameter of the circle.

The plated steel sheet according to an exemplary embodiment of the present invention includes a cold-rolled steel sheet and a plating layer located on one surface or both surfaces of the cold-rolled steel sheet.

Specifically, the plating layer may include at least one of aluminum and zinc.

A method for manufacturing a cold-rolled steel sheet according to an exemplary embodiment of the present invention includes manufacturing a hot-rolled steel sheet by hot rolling on a slab containing at most 0.004 wt % (exclusive of 0 wt %) of C, at most 0.02 wt % (exclusive of 0 wt %) of Si, 0.1 to 0.3 wt % of Mn, at most 0.05 wt % (exclusive of 0 wt %) of Al, at most 0.02 wt % (exclusive of 0 wt %) of P, at most 0.001 wt % (exclusive of 0 wt %) of S, at most 0.004 wt % (exclusive of 0 wt %) of N, 0.015 to 0.035 wt % of Ti, and 0.001 to 0.003 wt % of B, with the balance being Fe and other inevitable impurities; and manufacturing the cold-rolled steel sheet by cold rolling the hot-rolled steel sheet at a reduction ratio of 30 to 75%.

Hereinafter, each step will be described in detail.

First, the slab is hot-rolled to manufacture the hot-rolled steel sheet.

Since the alloy composition of the slab is the same as that of the cold-rolled steel sheet described above, overlapping description thereof will be omitted. Since the alloy composition is not substantially changed during the manufacturing process of the cold-rolled steel sheet, the alloy composition of the slab and the cold-rolled steel sheet is substantially the same.

The slab may be reheated to a temperature of 1150° C. or higher before the hot rolling. Since most precipitates present in the steel should be re-dissolved, a temperature of 1150° C. or higher may be required. More specifically, it may be heated to 1200° C. or higher in order to dissolve the precipitate well.

The hot-rolled steel sheet is manufactured by hot finish rolling the annealed slab at a temperature of Ar₃ or higher. The reason for limiting the hot rolling finishing temperature to Ar₃ or higher is to perform rolling in the austenite single phase region.

The Ar₃ temperature may be calculated by the following Equation.

Ar₃=910−(310×[C])−(80×[Mn])−(20×[Cu])−(15×[Cr])−(55×[Ni])−(80×[Mo])−(0.35×(25.4×8))

[C], [Mn], [Cu], [Cr], [Ni], and [Mo] are the contents (wt %) of C, Mn, Cu, Cr, Ni and Mo in the steel sheet, respectively.

The hot-rolled steel sheet may be wound at 550 to 700° C. Excellent aging resistance may be secured because N, which is still in a dissolved state, may be additionally precipitated as AIN by winding at 550° C. or higher. In the case of winding at less than 550° C., there is a risk that processability may be deteriorated due to the solid solution N remaining without precipitation as AlN. In the case of winding at more than 700° C., the crystal grains may be coarsened, which may decrease cold rollability.

Next, the hot-rolled steel sheet is cold rolled.

In this case, the cold-rolled steel sheet is manufactured by cold rolling at a reduction ratio of 30 to 75%. The reduction ratio determines the final thickness and final material of the cold-rolled steel sheet. when the reduction ratio is lower than 30%, it is difficult to obtain the target thickness due to the thickness limitation of the hot-rolled steel sheet, and when the reduction ratio exceeds 75%, the steel is excessively hardened and it is difficult to secure formability. More specifically, it may be cold-rolled at a reduction ratio of 30 to 70%.

Thereafter, a plated steel sheet may be manufactured by hot-dip plating or electroplating on one surface or both sides of the cold-rolled steel sheet to form a plating layer.

The cold-rolled steel sheet having excellent hardness and processability according to an exemplary embodiment of the present invention may have hardness (HRB) of 75 or more, and an elongation of 3% or more. More specifically, the hardness (HRB) may be 75 to 88.0, and the elongation may be 3.3 to 5.0%.

The cold-rolled steel sheet according to an exemplary embodiment of the present invention has excellent aging. The aging may be 0.1 to 1.5 MPa.

More specifically, the aging may be 0.5 to 1.1 MPa. The aging is an indicator of material change over time, and it is possible to measure the amount of increase in yield strength that appears after accelerated aging by maintaining at 100° C. for 1 hour.

Hereinafter, the present invention will be described in more detail through examples. However, these examples are only for illustrating the present invention, and the present invention is not limited thereto.

### EXAMPLES

Steel having the composition shown in Table 1 below and the balance including Fe and inevitable impurities was prepared, and the components are indicated by performance values. The steel slab having the composition of Table 1 was reheated to 1250° C., hot-rolled at 910° C., wound at 640° C., and cold-rolled at a reduction ratio of 25 to 80%.

TABLE 1

| Compositional | Component (wt %) | | | | | | | | |
|---|---|---|---|---|---|---|---|---|---|
| system | C | Si | Mn | Al | P | S | N | Ti | B |
| A1 | 0.0025 | 0.011 | 0.186 | 0.022 | 0.01 | 0.008 | 0.0028 | 0.02 | 0.0021 |
| A2 | 0.0034 | 0.011 | 0.152 | 0.026 | 0.011 | 0.007 | 0.0032 | 0.021 | 0.0023 |
| A3 | 0.0034 | 0.011 | 0.193 | 0.041 | 0.011 | 0.007 | 0.0036 | 0.018 | 0.0020 |
| A4 | 0.0028 | 0.012 | 0.191 | 0.049 | 0.010 | 0.008 | 0.0035 | 0.023 | 0.0015 |
| A5 | 0.0035 | 0.009 | 0.206 | 0.044 | 0.011 | 0.008 | 0.0020 | 0.030 | 0.0015 |
| B | 0.0055 | 0.01 | 0.181 | 0.025 | 0.008 | 0.008 | 0.0029 | 0.022 | 0.0022 |
| C | 0.0034 | 0.026 | 0.18 | 0.044 | 0.01 | 0.006 | 0.004 | 0.019 | 0.0022 |
| D1 | 0.0026 | 0.011 | 0.352 | 0.044 | 0.009 | 0.007 | 0.0024 | 0.019 | 0.0019 |
| D2 | 0.0029 | 0.009 | 0.43 | 0.026 | 0.009 | 0.007 | 0.0033 | 0.016 | 0.0017 |
| D3 | 0.0029 | 0.009 | 0.551 | 0.028 | 0.01 | 0.008 | 0.0033 | 0.023 | 0.002 |
| E | 0.0034 | 0.01 | 0.195 | 0.037 | 0.01 | 0.006 | 0.0056 | 0.024 | 0.0017 |
| F1 | 0.0025 | 0.012 | 0.215 | 0.028 | 0.011 | 0.007 | 0.0038 | 0.01 | 0.0021 |
| F2 | 0.0033 | 0.009 | 0.184 | 0.037 | 0.008 | 0.007 | 0.0032 | 0.045 | 0.0019 |
| G1 | 0.0028 | 0.008 | 0.19 | 0.023 | 0.008 | 0.007 | 0.0025 | 0.024 | 0.0005 |
| G2 | 0.0029 | 0.011 | 0.219 | 0.028 | 0.011 | 0.008 | 0.0032 | 0.019 | 0.0035 |

The following crystal grain aspect ratio, hardness, elongation, aging, plating ability, and weldability were evaluated for the manufactured cold-rolled steel sheet, and are shown in Table 2 below. The crystal grain aspect ratio was defined by Equation 1 below and may be measured through optical observation. The hardness was measured through the Rockwell hardness (HRB) measurement, and the elongation was measured through the tensile test.

The aging is an indicator of material change over time, and the amount of increase in yield strength that appears after accelerated aging was maintained at 100° C. for 1 hour was measured and compared. In addition, since the cold-rolled steel sheet of the present invention is mainly used after surface treatment such as plating, the presence or absence of abnormality on the surface was confirmed through Zn hot-dip plating. In this case, when more than 0.1% of non-plating was confirmed by area ratio, the plating ability was determined to be poor. TIG welding was performed to determine weldability, and when the crystal grain diameter was coarsened to more than 100 μm, the weldability was determined to be poor.

TABLE 2

| | | Cold | Crystal grain | | | | | |
|---|---|---|---|---|---|---|---|---|
| | | reduction | aspect ratio | | | | | |
| | Compositional | ratio | (Relational | Hardness | Elongation | Aging | Plating | |
| Division | system | (%) | Expression 1) | (HRB) | (%) | (MPa) | ability | Weldability |
| Comparative | A1 | 25 | 1.32 | 72.5 | 8.2 | 1.3 | Good | Good |
| Steel 1 | | | | | | | | |
| Developed | A1 | 30 | 1.42 | 78.5 | 5.2 | 1.3 | Good | Good |
| steel 1 | | | | | | | | |
| Developed | A1 | 40 | 1.60 | 81.3 | 4.5 | 1.1 | Good | Good |
| steel 2 | | | | | | | | |
| Developed | A1 | 50 | 2.03 | 83.1 | 4.0 | 0.5 | Good | Good |
| steel 3 | | | | | | | | |
| Developed | A1 | 60 | 2.45 | 86.5 | 3.7 | 0.8 | Good | Good |
| steel 4 | | | | | | | | |
| Developed | A1 | 70 | 3.81 | 87.0 | 3.4 | 1.1 | Good | Good |
| steel 5 | | | | | | | | |
| Developed | A2 | 50 | 2.02 | 83.2 | 3.9 | 0.8 | Good | Good |
| steel 6 | | | | | | | | |
| Developed | A3 | 50 | 2.16 | 82.9 | 4.0 | 0.9 | Good | Good |
| steel 7 | | | | | | | | |
| Developed | A4 | 50 | 2.12 | 83.3 | 4.0 | 0.6 | Good | Good |
| steel 8 | | | | | | | | |
| Developed | A5 | 50 | 2.15 | 81.9 | 4.1 | 1.0 | Good | Good |
| steel 9 | | | | | | | | |
| Comparative | A1 | 80 | 5.12 | 92.8 | 1.2 | 0.2 | Good | Good |
| steel 2 | | | | | | | | |
| Comparative | B | 50 | 2.10 | 83.0 | 3.9 | 31.5 | Good | Good |
| steel 3 | | | | | | | | |
| Comparative | C | 50 | 2.20 | 83.7 | 4.3 | 1.2 | Bad | Good |
| steel 4 | | | | | | | | |
| Comparative | D1 | 50 | 1.90 | 90.6 | 1.8 | 0.8 | Good | Good |
| steel 5 | | | | | | | | |
| Comparative | D2 | 50 | 2.00 | 92.1 | 1.5 | 0.9 | Good | Good |
| steel 6 | | | | | | | | |
| Comparative | D3 | 50 | 1.88 | 94.5 | 0.9 | 1.1 | Good | Good |
| steel 7 | | | | | | | | |
| Comparative | E | 50 | 2.15 | 84.6 | 2.9 | 35.6 | Good | Good |
| steel 8 | | | | | | | | |
| Comparative | F1 | 50 | 2.14 | 79.6 | 5.2 | 33.3 | Good | Good |
| steel 9 | | | | | | | | |
| Comparative | F2 | 50 | 2.11 | 91.5 | 1.1 | 0.8 | Good | Good |
| steel 10 | | | | | | | | |
| Comparative | G1 | 50 | 2.10 | 82.1 | 3.8 | 1.1 | Good | Bad |
| steel 11 | | | | | | | | |
| Comparative | G2 | 50 | 1.85 | 92.5 | 1.5 | 1.0 | Bad | Good |
| steel 12 | | | | | | | | |

The developed steels 1 to 9 of Table 3 satisfy all the component ranges and have a crystal grain aspect ratio of 1.4 to 4.0 in the range of the cold rolling reduction ratio of 30 to 75%. In terms of material, it has a high hardness of 75 or more, so it is suitable to withstand external forces, the elongation is 3% or more, the increase in yield strength after the accelerated aging was 3 MPa or less, and it has a level of formability suitable for realizing a basic shape. In addition, the plating ability and the weldability are good, so there is no problem in use.

Comparative steel 1 has the same composition as the developed steel, but has a low cold-rolling ratio of 25%, so the crystal grain aspect ratio is as small as 1.32 in terms of structure. Since the cold rolling reduction ratio is low, the thickness of the hot-rolled sheet should be correspondingly thin to obtain the desired thickness. This has a problem in that it is a factor of lowering productivity because a load is applied during hot rolling. In addition, since it is a soft compositional system without a reinforcing mechanism in terms of components, there is a problem that the hardness is as low as 75 or less at 25% reduction.

On the other hand, Comparative Steel 2 has a high cold rolling reduction rate of 80% and a crystal grain aspect ratio of 5 or higher. In this case,

Comparative Steel 2 has high hardness but a low elongation of 2% or less, and therefore, Comparative Steel 2 is difficult to form.

Comparative steel 3 has an excessive content of C of 0.0055 wt %. In this case, since the increase in yield strength after accelerated aging is high as 30 MPa or more, Comparative Steel 3 has poor formability. When the content of C is high, the precipitation by Ti is not sufficient, and the solid solution C remains in the steel, and the solid solution C is the main cause of aging. In order to prevent this, Ti may be additionally added, but since it hardens the steel by precipitation hardening, it does not conform to the goal of the present invention to soften the steel and expand the range of the final cold reduction ratio.

For this reason, even when the content of C is as low as a desired level in the present invention, the content of Ti is important. Comparative Steel 9 had a low content of Ti of 0.010 wt %, which did not sufficiently precipitate C, and the yield strength increased by more than 30 MPa after accelerated aging by solid solution C, resulting in inferior formability. Comparative Steel 10 has a high content of Ti of 0.045 wt %, which is effective in preventing aging, but due to an excessive content of Ti, C precipitates, and the remaining Ti causes a solid solution strengthening effect in the steel, which results in disadvantages of lowering the elongation and lowering economic efficiency.

As the case where Comparative Steel 8 has the content of N is 0.0056 wt % or less, in the case where the content of N is as low as 0.004 wt % or less, N is combined with Al to form AlN, so there is no almost solid solution N and aging hardly occurs. However, when the content is excessive, it is difficult for Al to sufficiently precipitate N, so the solid solution N remains in the steel. As a result, the aging causes the increase in yield strength and lowers the formability.

Comparative Steel 11 has a small content of B of 0.0005 wt %, and therefore, it is difficult to prevent crystal grain growth during cooling after melting by welding, so that the crystal grains grow excessively to more than 100 μm, resulting in poor weldability. When B is added in a certain amount or more, B acts to effectively suppress the growth of crystal grains by segregating at the crystal grain interface. In order to obtain such an effect, B is preferably added in an amount of 0.001 wt % or more.

When B is excessive at 0.0035 wt % like Comparative Steel 12, since B makes steel hard by refining grains, the elongation is reduced to 3% or less, which is not preferable in terms of formability. Also, B tends to segregate on the surface, and B segregated on the surface forms an oxide by combining with oxygen in the air. Due to this, there is a problem that makes the plating ability inferior.

The present invention is not limited to the exemplary embodiments, but may be manufactured in a variety of different forms, and the present invention may be manufactured in a variety of different forms, and those of ordinary skill in the art to which the present invention pertains will understand that the present invention may be implemented in other specific forms without changing the technical spirit or essential features of the present invention. Therefore, it should be understood that the above-mentioned exemplary embodiments are exemplary in all aspects but are not limited thereto.

1. A cold-rolled steel sheet, comprising:
at most 0.004 wt % (exclusive of 0 wt %) of C, at most 0.02 wt % (exclusive of 0 wt %) of Si, 0.1 to 0.3 wt % of Mn, at most 0.05 wt % (exclusive of 0 wt %) of Al, at most 0.02 wt % (exclusive of 0 wt %) of P, at most 0.001 wt % (exclusive of 0 wt %) of S, at most 0.004 wt % (exclusive of 0 wt %) of N, 0.015 to 0.035 wt % of Ti, and 0.001 to 0.003 wt % of B, with the balance being Fe and other inevitable impurities, and
having a microstructure in which a crystal grain aspect ratio defined by the following equation 1 is 1.4 to 4.0.
Crystal grain aspect ratio=average crystal grain diameter in rolling direction/average crystal grain diameter in thickness direction [Equation 1]

2. The cold-rolled steel sheet of claim 1, further comprising:
at least one of at most 0.003 wt % of Cu, at most 0.01 wt % of Nb, at most 0.03 wt % of Sb, at most 0.03 wt % of Sn, at most 0.03 wt % of Ni, at most 0.03 wt % of Cr, and at most 0.03 wt % of Mo.

3. A plating steel comprising:
the cold-rolled steel sheet of claim 1 and a plating layer located on one surface or both surfaces of the cold-rolled steel sheet.

4. A method for manufacturing a cold-rolled steel sheet, comprising:
manufacturing a hot-rolled steel sheet by hot rolling on a slab containing at most 0.004 wt % (exclusive of 0 wt %) of C, at most 0.02 wt % (exclusive of 0 wt %) of Si, 0.1 to 0.3 wt % of Mn, at most 0.05 wt % (exclusive of 0 wt %) of Al, at most 0.02 wt % (exclusive of 0 wt %) of P, at most 0.001 wt % (exclusive of 0 wt %) of S, at most 0.004 wt % (exclusive of 0 wt %) of N, 0.015 to 0.035 wt % of Ti, and 0.001 to 0.003 wt % of B, with the balance being Fe and other inevitable impurities; and
manufacturing the cold-rolled steel sheet by cold rolling the hot-rolled steel sheet at a reduction ratio of 30 to 75%.

5. The method of claim 4, further comprising:
before manufacturing the hot-rolled steel sheet, heating the slab at 1150° C. or higher.

6. The method of claim 4, wherein:
the manufacturing the hot-rolled steel sheet includes hot finish rolling in Ar₃ or more.

7. The method of claim 4, wherein:
the manufacturing of the hot-rolled steel sheet includes winding at 550 to 700° C.

8. A method for manufacturing a plating steel sheet, comprising:
manufacturing a cold-rolled steel sheet by the method of claim 4; and
forming a plating layer by hot-dip plating or electroplating on one surface or both surfaces of the cold-rolled steel sheet.
